(19) United States
(12) Patent Application Publication
(10) Pub. No.: US 2015/0339906 A1
(43) Pub. Date: Nov. 26, 2015

(54) MONITORING SYSTEM, APPARATUS AND METHOD THEREOF

(71) Applicant: AVerMedia TECHNOLOGIES, INC., New Taipei City (TW)

(72) Inventors: Neng-Chia LEE, NEW TAIPEI CITY (TW); Yu-Hsiang CHEN, NEW TAIPEI CITY (TW); Hou-I LIU, NEW TAIPEI CITY (TW); Jiun-Kuei JUNG, NEW TAIPEI CITY (TW)

(21) Appl. No.: 14/719,335

(22) Filed: May 22, 2015

(30) Foreign Application Priority Data
May 23, 2014 (TW) 103118116

(51) Int. Cl. G08B 21/02; H04N 7/18

(52) U.S. Cl. CPC G08B 21/0208; H04N 7/18

(57) ABSTRACT

A monitoring system includes a monitored apparatus and a monitoring apparatus. The monitored apparatus includes an image capturing module and a first wireless communication module. The image capturing module is used for capturing a plurality of images. The first wireless communication module is used for receiving the images from the image capturing module. The monitoring apparatus includes a second wireless communication module, a distance determining module and an image playing module. The second wireless communication module is used for receiving the images from the first wireless communication module. The distance determining module is used for determining whether a distance from the monitored apparatus to the monitoring apparatus is greater than a predetermined value. The image playing module is used for playing at least one of the images when the distance is greater than the predetermined value.

### RELATED APPLICATIONS

This application claims priority to Taiwanese Application Serial Number 103118116, filed May 23, 2014, which is herein incorporated by reference.

### BACKGROUND

1. Technical Field

Embodiments of The present invention relates to a monitoring system. More particularly, embodiments of the present invention relate to a monitoring system, apparatus and method thereof.

2. Description of Related Art

To prevent the child or items from getting lost, a surveillance device is developed to outputting alerting signal to remind the user of the monitoring apparatus when the child or the item is far from a distance greater than a particular value to the user.

Take monitoring the child for example, the user can be equipped with the surveillance device, and the child with a tracker. The surveillance device can be coupled to the tracker in a wireless communication manner. When the strength of the communication signal transferred between the tracker and the surveillance device is lower than a particular value, the surveillance device determines that the surveillance device is too far away from the surveillance device. In other words, the child has moved out of the monitoring range of the user. At this time, the surveillance device can output the alerting signal to remind the user.

The alerting signal outputted by the surveillance device only reminds the user that the child has moved out of the monitoring range, but cannot inform the user where the child is or what happened to the child at the moment that the child moves out of the monitoring range. As a result, even though the user is reminded that the child has moved out of the monitoring range, the user cannot obtain the specific situation about the child.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One aspect of the present invention is to enable the user of the monitoring apparatus to obtain where the monitored subject is or what happened to the monitored subject when the monitored subject moves out of the monitoring range.

In accordance with one embodiment of the present invention, a monitoring system includes a monitored apparatus and a monitoring apparatus. The monitored apparatus includes an image capturing module and a first wireless communication module. The image capturing module is used for capturing a plurality of images. The first wireless communication module is used for receiving the images from the image capturing module. The monitoring apparatus includes a second wireless communication module, a distance determining module and an image playing module. The second wireless communication module is used for receiving the images from the first wireless communication module. The distance determining module is used for determining whether a distance from the monitored apparatus to the monitoring apparatus is greater than a predetermined value. The image playing module is used for playing at least one of the images when the distance is greater than the predetermined value.

In accordance with another embodiment of the present invention, a monitoring apparatus includes a wireless communication module, a distance determining module and an image playing module. The wireless communication module is used for receiving the images from a monitored apparatus. The distance determining module is used for determining whether a distance from the monitored apparatus to the monitoring apparatus is greater than a predetermined value. The image playing module is used for playing at least one of the images when the distance is greater than the predetermined value.

In accordance with another embodiment of the present invention, a monitoring method includes following steps. A monitoring apparatus is utilized to wirelessly receive a plurality of images captured by a monitored apparatus. Whether a distance from the monitored apparatus to the monitoring apparatus is greater than a predetermined value is determined. When the distance is greater than the predetermined value, at least one of the images is played.

In the foregoing embodiments, as long as the distance from the monitored device to the monitoring device is greater than the predetermined value, the monitoring device can play the image captured by the monitored apparatus. As a result, the user of the monitoring apparatus can obtain where the monitored subject is or what happened to the monitored subject based on the image.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a monitoring system in accordance with one embodiment of the present invention;

FIG. 2 is a flow chart of the monitoring method executed by the monitoring apparatus in FIG. 1;

FIG. 3 is a block diagram of a monitoring system in accordance with another embodiment of the present invention;

FIG. 4 is a flow chart of a monitoring method executed by the monitoring apparatus in FIG. 3;

FIG. 5 is a block diagram of a monitoring system in accordance with another embodiment of the present invention;

FIG. 6 is a block diagram of a monitoring system in accordance with another embodiment of the present invention; and

FIG. 7 is a block diagram of a monitoring system in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

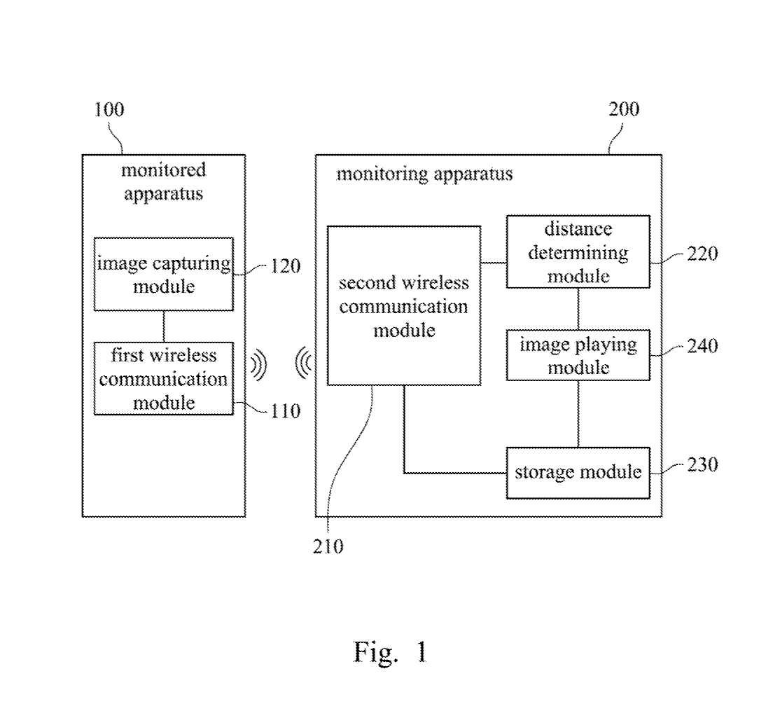

FIG. 1 is a block diagram of a monitoring system in accordance with one embodiment of the present invention. As shown in FIG. 1, in this embodiment, the monitoring system includes a monitored apparatus 100 and a monitoring apparatus 200. The monitored apparatus 100 includes a first wireless communication module 110 and an image capturing module 120. The image capturing module 120 can used to capture a plurality of images. It is understood that the image capturing module 120 refers to any software or hardware capable of capturing images, such as the image capturing program having the image capturing function, the audio/video capturing program having the image capturing function or the multimedia program having the image capturing function. The first wireless communication module 110 can be electrically connected to the image capturing module 120, so that the first wireless communication module 110 receives the images from the image capturing module 120. The monitoring apparatus 200 includes a second wireless communication module 210, a distance determining module 220, a storage module 230 and an image playing module 240. The second wireless communication module 210 can receives the images from the first wireless communication module 110. The storage module 230 can be electrically connected to the second wireless communication module 210, so as to store the images received by the second wireless communication module 210. The distance determining module 220 can determine whether a distance from the monitored apparatus 100 to the monitoring apparatus 200 is greater than a predetermined value. The image playing module 240 can be electrically connected to the distance determining module 220 and the storage module 230. When the distance is greater than the predetermined value, the image playing module 240 can play at least one of the images stored in the storage module 230.

By the foregoing embodiment, as long as the monitored apparatus 100 moves out of the monitoring range of the monitoring apparatus 200 (namely, when the distance from the monitored apparatus 100 to the monitoring apparatus 200 is greater than the predetermined value), the monitoring apparatus 200 can play at least one of the images that the monitored apparatus 100 captures. As a result, the user of the monitoring apparatus 200 can obtain where the monitored subject is or what happened to the monitored subject based on the image.

In some embodiments, the image capturing module 120 captures the images periodically, and the first wireless communication module 110 transmits the images to the second wireless communication module 210 periodically as well. When the distance determining module 220 determines that the distance is greater than the predetermined value, it can request the image playing module 240 to play one of the images that is captured lastly. In other words, the image playing module 240 can play the latest image, which is captured by the image capturing module 120 at the moment closest to the time that the monitored apparatus 100 moves out of the monitoring range. As a result, the user of the monitoring apparatus 200 can obtain where the monitored subject is or what happened to the monitored subject at the moment closest to the time that the monitored apparatus 100 moves out of the monitoring range. Moreover, in addition to determining the situation of the monitored subject based on the captured image, other multimedia information, such as the audio/video, can be utilized to determine the situation of the monitored subject, so as to provide the user more choices.

In some embodiments, when the distance determining module 220 determines that the distance is greater than the predetermined value, the image playing module 240 can play the images according to a sequence of capturing times of the images. In other words, the image playing module 240 can play the images from the earlier one to the latest one. As a result, the user of the monitoring apparatus 200 can obtain the track of the monitored subject within a period (such as 10 minutes) before the monitored subject moves out of the monitoring range.

In some embodiments, the image capturing module 120 captures plural images (such as 120 images) per second, and the storage module 230 stores the images. When the image playing module 240 plays the images according to the sequence of capturing times of the images, a dynamic video is played. It is understood that the number of the images captured per second is only exemplary, not used to limit the present invention. In some embodiments, the image capturing module 120 includes, but is not limited to include, the CCD (charge-coupled device), or the CMOS (complementary metal-oxide-semiconductor). In some embodiments, the storage module 230 includes, but is not limited to include, the non-volatile memory. In some embodiments, the image playing module 240 includes, but is not limited to include, the display such as the LCD or the EPD.

In some embodiments, the distance determining module 220 obtains the distance from the monitored apparatus 100 to the monitoring apparatus 200 according to a strength of a wireless signal transmitted from the first wireless communication module 110 to the second wireless communication module 210. Further, a minimal value of the strength of the wireless signal can be predefined in the distance determining module 220. When the strength of the wireless signal from the first wireless communication module 110 to the second wireless communication module 210 is lower than the foregoing minimal value, the distance determining module 220 determines that the distance from the monitored apparatus 100 to the monitoring apparatus 200 is greater than the predetermined value. As a result, the distance from the monitored apparatus 100 to the monitoring apparatus 200 can be obtained based on the strength of the signal transferred therebetween without additionally installing a GPS device.

In particular, in some embodiments, the first wireless communication module 110 and the second wireless communication module 210 are communicatively coupled in a peer-to-peer manner. As a result, the first wireless communication module 110 can transmit wireless signal to the second wireless communication module 210. The distance determining module 220 can obtain the distance from the monitored apparatus 100 to the monitoring apparatus 200 according to RSSI (received signal strength indicator) of the received signal of the second wireless communication module 210. Moreover, the distance determining module 220 can determine the minimal value of RSSI based on the required predetermined value. As a result, the distance determining module 220 can determine whether RSSI of the received signal of the second wireless communication module 210 is lower than the minimal value, so as to determine whether the distance is greater than the predetermined value.

For example, when the RSSI of the received signal of the second wireless communication module 210 is lower than −73 dBm, the distance determining module 220 determines that the distance from the monitored apparatus 100 to the monitoring apparatus 200 is greater than the predetermined value, so as to determine that the monitored apparatus 100 is located out of the monitoring apparatus 200. It is understood that the foregoing RSSI value is just exemplary, not used to limit the present invention. In some embodiments, the distance determining module 220 can be, but is not limited to be, implemented by the software of firmware installed in the monitoring apparatus 200.

In some embodiment, when the first wireless communication module 110 and the second wireless communication module 210 are communicatively coupled in a peer-to-peer manner, the first wireless communication module 110 can directly transmit the images to the second wireless communication module 210 without transmitting through a server. In some embodiments, the first wireless communication module 110 and the second wireless communication module 210 can be, but is not limited to be, the communication module compatible with IEEE b 802.11 or Bluetooth® protocol.

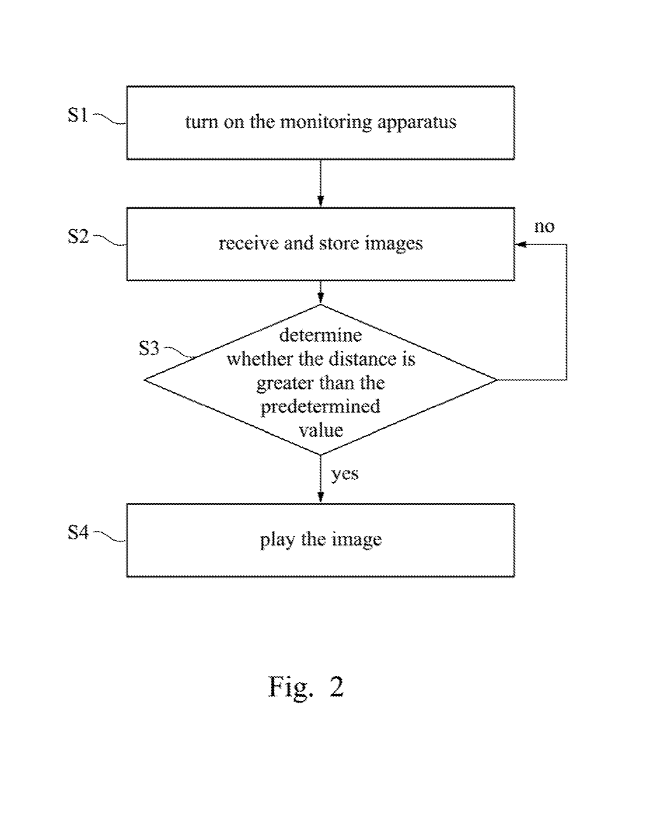

FIG. 2 is a flow chart of the monitoring method executed by the monitoring apparatus 200 in FIG. 1. As shown in FIG. 2, in step S1, the monitoring apparatus 200 can be turned on. For example, the power source of the monitoring apparatus 200 can be turn to enable the second wireless communication module 210, the distance determining module 220, the storage module 230 and the image playing module 240.

Then, in step S2, the monitoring apparatus 200 can be utilized to wirelessly receive the images captured by the monitored apparatus 100. For example, the image capturing module 120 of the monitored apparatus 100 can periodically capture images, and the first wireless communication 110 can periodically transmit the images to the second wireless communication module 210, and the images can be stored in the storage module 230.

Then, in step S3, whether the distance from the monitored apparatus 100 to the monitoring apparatus 200 is greater than the predetermined value is determined. For example, the distance determining module 220 of the monitoring apparatus 200 can obtain the distance from the monitored apparatus 100 to the monitoring apparatus 200 according to the strength of the wireless signal transmitted from the first wireless communication module 110 to the second wireless communication module 210. Moreover, a minimal value of the strength of the wireless signal can be predefined in the distance determining module 220. When the strength of the wireless signal from the first wireless communication module 110 to the second wireless communication module 210 is lower than the foregoing minimal value, the distance determining module 220 determines that the distance from the monitored apparatus 100 to the monitoring apparatus 200 is greater than the predetermined value.

If the distance from the monitored apparatus 100 to the monitoring apparatus 200 is not greater than the predetermined value, return to step S2. The monitoring apparatus 200 can keep receiving and storing the image lastly captured by the monitored apparatus 100. If the distance from the monitored apparatus 100 to the monitoring apparatus 200 is greater than the predetermined value, step S4 is performed.

In step S4, the monitoring apparatus 200 can play the image. For example, in some embodiments, the image playing module 240 can play one of the images that is captured lastly, so that the user of the monitoring apparatus 200 can obtain where the monitored subject is or what happened to the monitored subject at the moment closest to the time that the monitored apparatus 100 moves out of the monitoring range. In other embodiments, the image playing module 240 can play the images according to the sequence of capturing times of the images, so that the user of the monitoring apparatus 200 can obtain the track of the monitored subject within a period (such as 10 minutes) before the monitored subject moves out of the monitoring range.

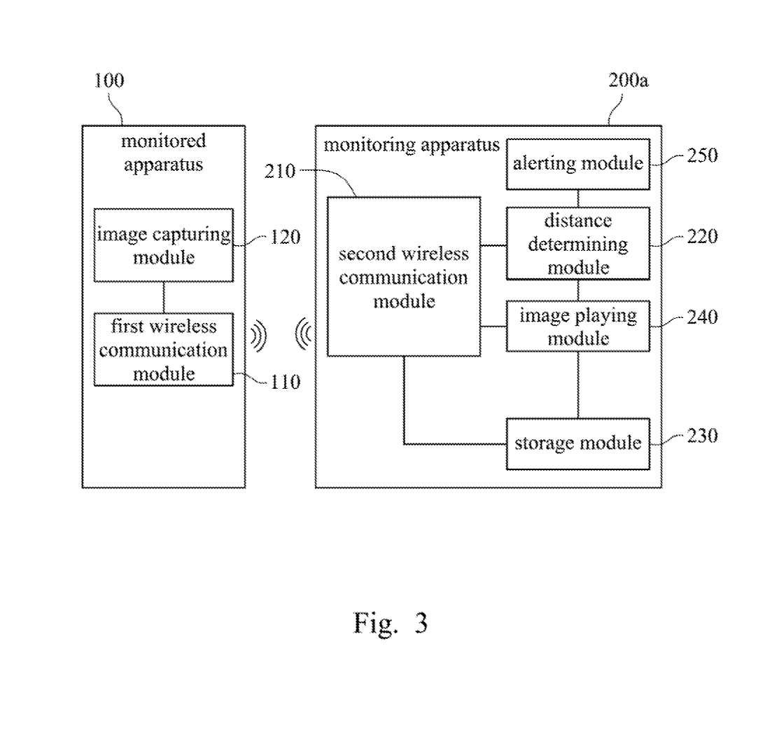

FIG. 3 is a block diagram of a monitoring system in accordance with another embodiment of the present invention. As shown in FIG. 3, the main difference between this embodiment and the foregoing embodiment is that: the monitoring apparatus 200a further includes an alerting module 250. The alerting module 250 can output an alerting signal when the distance is greater than the predetermined value. In particular, the alerting module 250 can be electrically connected to the distance determining module 220. When the distance determining module 220 determines that the distance is greater than the predetermined value, it can request the alerting module 250 to output the alerting signal. As a result, when the monitored apparatus 100 moves out of the monitoring range of the monitoring apparatus 200a, the user of the monitoring apparatus 200a can be reminded by the alerting signal, so as to immediately note that the monitored apparatus 100 moves out of the monitoring range, so that the user can immediately search the monitored subject. In some embodiments, the alerting signal includes, but is not limited to, sound. For example, the alerting module 250 can include a speaker. When the distance determining module 220 determines that the distance is greater than the predetermined value, the speaker can make a specific sound to remind the user of the monitoring apparatus 200a.

It is noted that other elements shown in FIG. 3 are the same as which are shown in FIG. 1 and the functions are described in the foregoing context, and therefore, they are not described repeatedly.

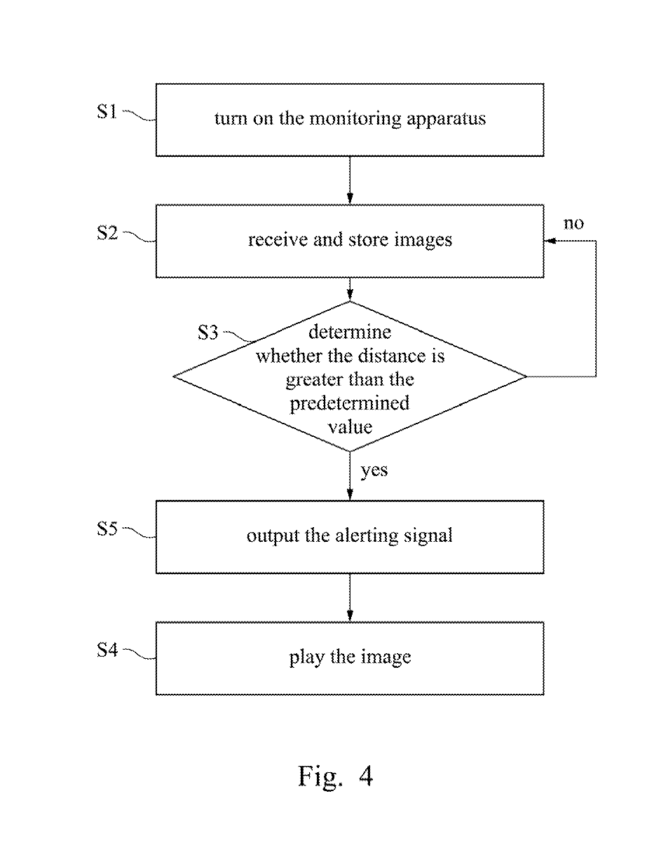

FIG. 4 is a flow chart of a monitoring method executed by the monitoring apparatus 200a in FIG. 3. As shown in FIG. 4, in step S1, the monitoring apparatus 200a can be turned on. Then, in step S2, the monitoring apparatus 200a can be utilized to wirelessly receive the images captured by the monitored apparatus 100. Then, in step S3, whether the distance from the monitored apparatus 100 to the monitoring apparatus 200a is greater than the predetermined value is determined.

If the distance from the monitored apparatus 100 to the monitoring apparatus 200a is not greater than the predetermined value, return to step S2. The monitoring apparatus 200a can keep receiving and storing the image lastly captured by the monitored apparatus 100. If the distance from the monitored apparatus 100 to the monitoring apparatus 200a is greater than the predetermined value, step S5 is performed.

In step S5, the alerting signal can be outputted. For example, in some embodiments, the alerting module 250 can be utilized to output the alerting signal (such as the sound), so as to remind the user of the monitoring apparatus 200a.

Then, in step S4, the image can be played. In other words, the alerting signal is outputted before the images are played. As a result, the alerting signal can be used to remind the user in advance, so as to prevent the images from being played before user notes that the monitored apparatus 100 moves out of the monitoring range. In some embodiments, when the alerting signal is outputted, the monitoring apparatus 200a can allow the user to choose whether keeping playing the images or not.

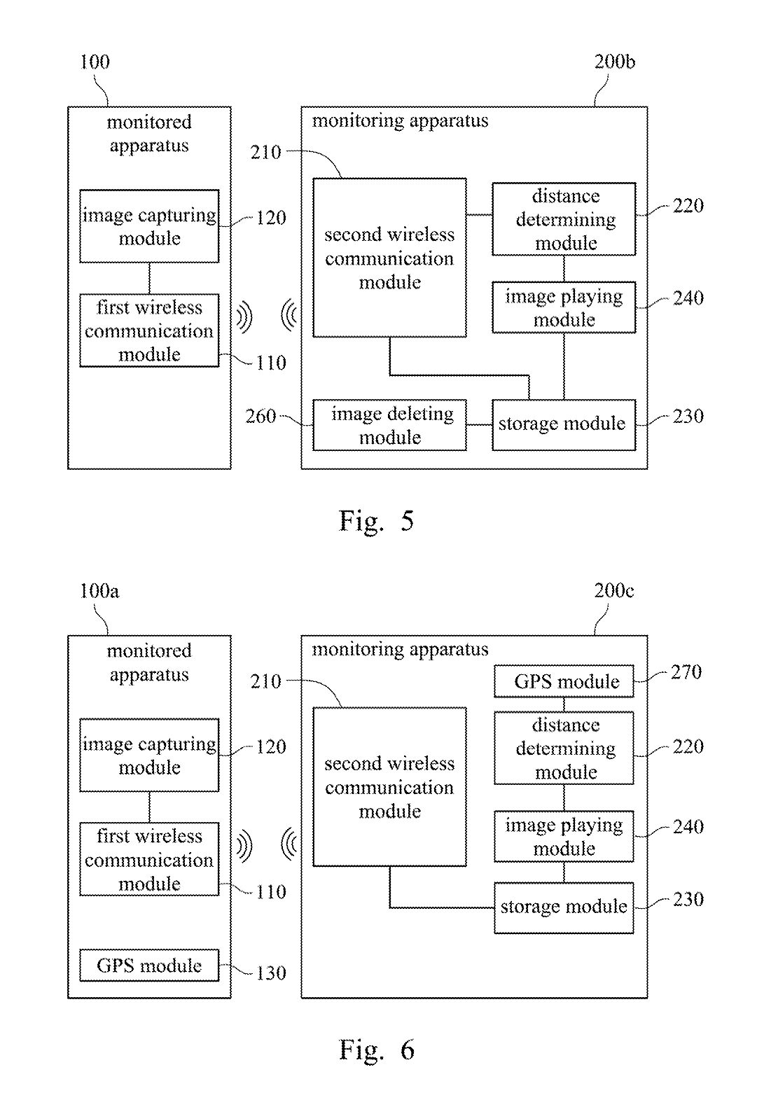

FIG. 5 is a block diagram of a monitoring system in accordance with another embodiment of the present invention. As shown in FIG. 5, the main difference between this embodiment and the foregoing embodiment is that: the monitoring apparatus 200b further includes an image deleting module 260. The image deleting module 260 can be electrically connected to the storage module 230, and is used to delete one of the images stored in the storage module 230 that is captured earliest. In particular, the storage module 230 can be set to store a particular number of images. When the images stored in the storage module 230 reaches the particular number, the storage module 230 can delete one of the images that is captured earliest, which not only updates the images stored in the storage module 230, but also prevents too many images occupying the capacity of the storage module 230. For example, the storage module 230 can be set to store the images captured within the latest 10 minutes, and the image deleting module 260 can delete the images captured before 10 minutes.

It is noted that other elements shown in FIG. 5 are the same as which are shown in FIG. 1 and the functions are described in the foregoing context, and therefore, they are not described repeatedly.

FIG. 6 is a block diagram of a monitoring system in accordance with another embodiment of the present invention. As shown in FIG. 6, the main difference between this embodiment and the foregoing embodiment is that: the monitored apparatus 100a further includes a GPS module 130, and the monitoring apparatus 200c further includes a GPS module 270. The distance determining module 220 is electrically connected to the GPS module 270, so as to obtain a GPS data of the monitoring apparatus 200c and a GPS data of the monitored apparatus 100a. As a result, the distance determining module 220 can more precisely obtain the distance from the monitored apparatus 100a to the monitoring apparatus 200c according the GPS data of the monitoring apparatus 200c and the GPS data of the monitored apparatus 100a. Further, the distance determining module 220 can stores a predetermined value of the maximal acceptable distance. By determining whether the distance is greater than the foregoing predetermined value, the distance determining module 220 can determine whether the monitored apparatus 100a moves out of the monitoring range of the monitoring apparatus 200c.

It is noted that other elements shown in FIG. 6 are the same as which are shown in FIG. 1 and the functions are described in the foregoing context, and therefore, they are not described repeatedly.

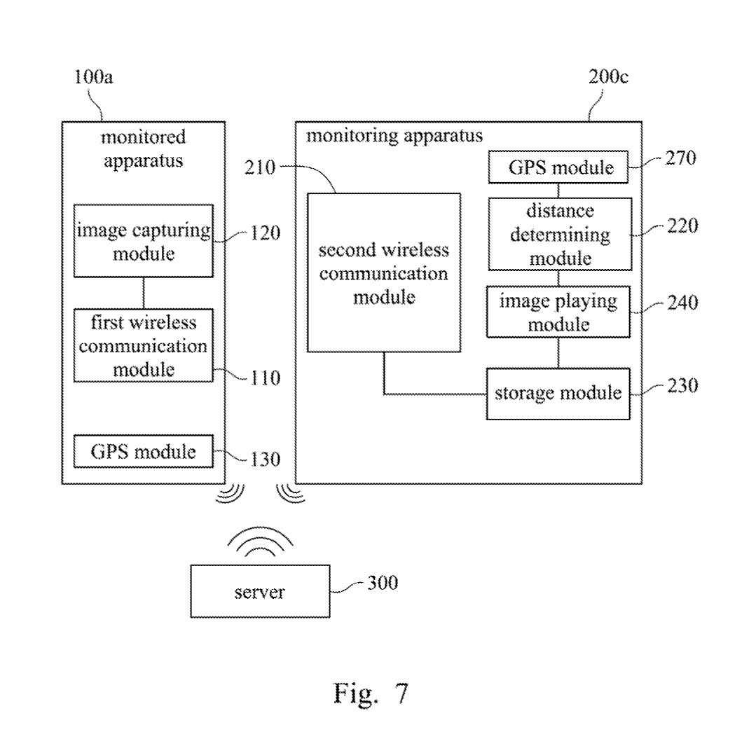

FIG. 7 is a block diagram of a monitoring system in accordance with another embodiment of the present invention. As shown in FIG. 7, the main difference between this embodiment and the foregoing embodiment is that: the monitoring system includes a server 300. The first wireless communication module 110 and the second wireless communication module 210 are communicatively coupled to the server 300. The first wireless communication module 110 can upload the images to the server 300, and the second wireless communication module 210 can download the images from the server 300. In other words, the first wireless communication module 110 and the second wireless communication module 210 can be not communicatively coupled in the peer-to peer manner. In stead, the first wireless communication module 110 and the second wireless communication module 210 can transfer images via the server 300.

As a result, even though the first wireless communication module 110 is too far away from the second wireless communication module 210 and cannot establish the wireless communication, the first wireless communication module 110 can still upload the images to the server 300, and the second wireless communication module 210 can still download the images from the server 300. In other words, even though the monitored apparatus 100a moves out of the monitoring range of the monitoring apparatus 200e, the second wireless communication module 210 can still update the latest images captured by the image capturing module 120, thereby obtaining the immediate image around the monitored subject, which facilitates to search the monitored subject.

It is noted that other elements shown in FIG. 7 are the same as which are shown in FIG. 1 and the functions are described in the foregoing context, and therefore, they are not described repeatedly.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A monitoring system, comprising:
a monitored apparatus comprising:
an image capturing module for capturing a plurality of images; and
a first wireless communication module for receiving the images from the image capturing module; and
a monitoring apparatus comprising:
a second wireless communication module for receiving the images from the first wireless communication module;
a distance determining module for determining whether a distance from the monitored apparatus to the monitoring apparatus is greater than a predetermined value; and
an image playing module for playing at least one of the images when the distance is greater than the predetermined value.

2. The monitoring system of claim 1 wherein when the distance is greater than the predetermined value, the image playing module is used for playing one of the images that is captured lastly.

3. The monitoring system of claim 1, wherein when the distance is greater than the predetermined value, the image playing module is used for playing the images according to a sequence of capturing times of the images.

4. The monitoring system of claim 1, wherein the monitoring apparatus further comprises:
an image deleting module for deleting one of the images that is captured earliest.

5. The monitoring system of claim 1, wherein the monitoring apparatus further comprises:
an alerting module for outputting an alerting signal when the distance is greater than the predetermined value.

6. The monitoring system of claim 1, wherein the distance determining module is used for obtaining the distance from the monitored apparatus to the monitoring apparatus according to a strength of a wireless signal transmitted from the first wireless communication module to the second wireless communication module.

7. The monitoring system of claim 1, wherein the distance determining module is used for obtaining the distance from the monitored apparatus to the monitoring apparatus according a GPS data of the monitored apparatus and a GPS data of the monitoring apparatus.

8. The monitoring system of claim 1, wherein the first wireless communication module and the second wireless communication module are communicatively coupled in a peer-to-peer manner, such that the first wireless communication module directly transmits the images to the second wireless communication module.

9. The monitoring system of claim 1, wherein the first wireless communication module and the second wireless communication module are communicatively coupled to a server, wherein the first wireless communication module is used for uploading the images to the server, and the second wireless communication module is used for downloading the images from the server.

10. A monitoring apparatus, comprising:
a wireless communication module for receiving the images from a monitored apparatus;
a distance determining module for determining whether a distance from the monitored apparatus to the monitoring apparatus is greater than a predetermined value; and
an image playing module for playing at least one of the images when the distance is greater than the predetermined value.

11. The monitoring apparatus of claim 10, wherein when the distance is greater than the predetermined value, the image playing module is used for playing one of the images that is captured lastly.

12. The monitoring apparatus of claim 10, wherein when the distance is greater than the predetermined value, the image playing module is used for playing the images according to a sequence of capturing times of the images.

13. The monitoring apparatus of claim 10, further comprising:
an image deleting module for deleting one of the images that is captured earliest.

14. The monitoring apparatus of claim 10, further comprising:
an alerting module for outputting an alerting signal when the distance is greater than the predetermined value.

15. The monitoring apparatus of claim 10, wherein the distance determining module is used for obtaining the distance from the monitored apparatus to the monitoring apparatus according to a strength of a wireless signal transmitted from the monitored apparatus to the monitoring apparatus.

16. The monitoring apparatus of claim 10, wherein the distance determining module is used for obtaining the distance from the monitored apparatus to the monitoring apparatus according a GPS data of the monitored apparatus and a GPS data of the monitoring apparatus.

17. A monitoring method, comprising:
(a) utilizing a monitoring apparatus to wirelessly receive a plurality of images captured by a monitored apparatus;
(b) determining whether a distance from the monitored apparatus to the monitoring apparatus is greater than a predetermined value; and
(c) playing at least one of the images when the distance is greater than the predetermined value.

18. The monitoring method of claim 17, wherein the step (c) comprises:
playing one of the images that is captured lastly when the distance is greater than the predetermined value.

19. The monitoring method of claim 17, wherein the step (c) comprises:
playing the images according to a sequence of capturing times of the images when the distance is greater than the predetermined value.

20. The monitoring method of claim 17, further comprising:
deleting one of the images that is captured earliest.

21. The monitoring method of claim 17, further comprising:
outputting an alerting signal when the distance is greater than the predetermined value.

22. The monitoring method of claim 21, wherein the alerting signal is outputted before the images are played.
